(19) United States
(12) Patent Application Publication
(10) Pub. No.: US 2022/0400605 A1
(43) Pub. Date: Dec. 22, 2022

(54) TOOL TO REMOVE WEEDS

(71) Applicant: Yoshio Yanez, San Bernadino, CA (US)

(72) Inventor: Yoshio Yanez, San Bernadino, CA (US)

(21) Appl. No.: 17/456,522

(22) Filed: Nov. 24, 2021

Related U.S. Application Data
(63) Continuation-in-part of application No. 17/348,809, filed on Jun. 16, 2021.

(51) Int. Cl. A01D 11/06; A01D 9/00

(52) U.S. Cl. CPC A01D 11/06; A01D 9/00

(57) ABSTRACT

A garden tool comprises a fork body with a base portion having upper and lower surfaces. The tool includes a plurality of elongated tines each having a first end connected to the base portion, and an opposed free end. A span element attaches to the base at an intermediate portion along the length of each tine, which are preferably parallel to each other. The span element includes one or more acute cutting edges, which may reside between adjacent tines, or may be connected to some or all of them, preferably being adjacent to the lower surface. According to one variant, the tines each include a plurality of span attachment facilities at different positions along their lengths. The span may have an elongated portion above the upper surface of the fork body. The tines may have opposed parallel sidewalls, and the tool may comprise three, four, five, or more tines.

### CROSS-REFERENCE TO RELATED APPLICATIONS

This application is a Continuation-in-Part of U.S. patent application Ser. No. 17/348,809 filed on Jun. 16, 2021, entitled “Tool to remove weeds,” which claims the benefit of U.S. Provisional Patent Application No. 63/041,316, filed on Jun. 19, 2020, entitled “Tool to remove weeds,” and of U.S. Provisional Patent Application No. 63/060,519, filed on Aug. 3, 2020, entitled “Tool to remove weeds”, which is hereby incorporated by reference in its entirety for all that is taught and disclosed therein.

### FIELD OF THE INVENTION

The present invention relates to a tool which may be used by a professional or home gardener to remove weeds and other unwanted plants that invariably grow in gardens and landscapes about a home or commercial site.

### BACKGROUND AND SUMMARY

Traditional garden tools are made specific to one task; for example, a weed eater removes weeds over a large area. However, a weed eater cannot target a small area and remove a few weeds at a time. Also, weed eaters are not effective at breaking up woody plants and roots. The above disadvantages are addressed by a garden tool that is comprised of a handle and a head having a plurality of parallel tines each having a free end. The garden tool also has a span perpendicular to the tines. The span is connected to each of the tines at an intermediate position along the length of each tine. The span has a sharpened edge configured to sever plant growth on the surface and beneath the soil surface.

### BRIEF DESCRIPTION OF THE DRAWINGS

FIG. 1 shows an oblique, top front left view of an embodiment of a weed removal tool in accordance with the invention, having five tines.

FIG. 2 shows an exploded view of the weed removal tool of FIG. 1.

FIG. 3a shows a top view of the weed removal tool of FIG. 1 and defines section lines A-A and B-B for the cross section views of FIGS. 3b and 3c respectively, and defines section line C-C for the cross section views of FIGS. 3d and 3e.

FIG. 3b shows a cross section view of the weed removal tool of FIG. 1 taken at section line A-A of FIG. 3a.

FIG. 3c shows a cross section view of the weed removal tool of FIG. 1 taken at section line B-B of FIG. 3a.

FIG. 3d shows a cross section view of the weed removal tool of FIG. 1 taken at section line C-C of FIG. 3a.

FIG. 3e shows a cross section view of a weed removal tool similar to that of FIG. 1 but having an alternative embodiment of a span element comprising integral cutting edges.

FIG. 4 shows an oblique, bottom front left view of an alternative embodiment of a weed removal tool in accordance with the invention having four tines, with its components exploded.

FIG. 5a shows a front view of an embodiment of a weed removal tool having two tines.

FIG. 5b shows a front view of an embodiment of a weed removal tool having three tines.

FIG. 5c shows a front view of an embodiment of the weed removal tool of FIG. 1.

FIG. 6a shows an environmental use of the weed removal garden tool of FIG. 1.

FIG. 6b shows another environmental use of a weed removal tool in accordance with the invention, wherein a user has severs a root below the soil surface.

### DETAILED DESCRIPTION OF A PREFERRED EMBODIMENT

The following description of the preferred embodiment(s) is merely exemplary in nature and is in no way intended to limit the invention, its application, or uses.

The present invention is directed towards a garden tool that may be used by professionals or home gardeners to remove weeds and other unwanted plants that invariably grow in gardens and landscapes about a home or commercial site. The tool improves the uses of a typical pitchfork by providing a chopping function which may be used to break up plant matter on the soil surface or below ground.

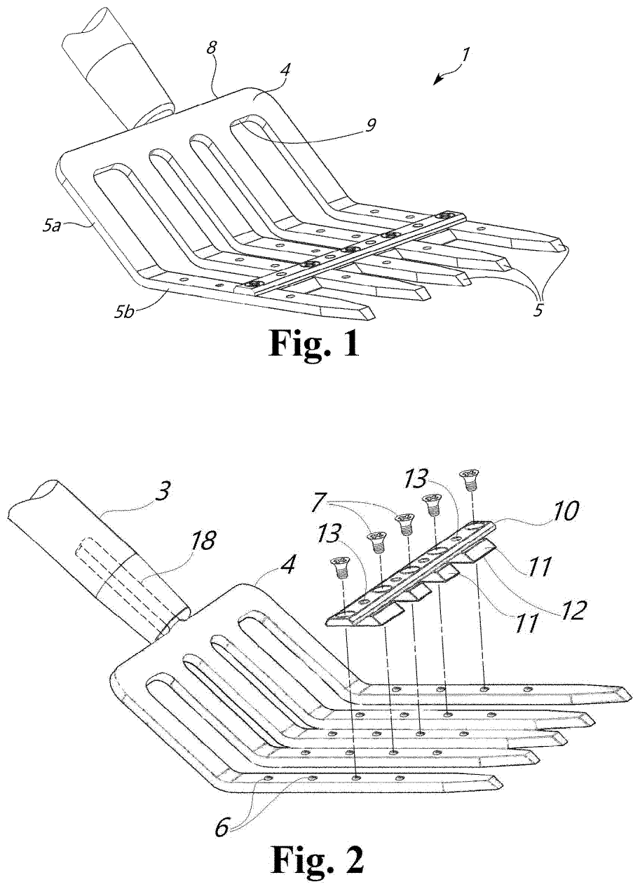

FIG. 1 shows an oblique, top front left view of an embodiment of a weed removal tool [1] in accordance with the invention, having five tines. The tool has a longitudinal handle that is optimally set to allow the operator of tool to utilize a maximum amount of upper body strength to use the tool. The handle may be constructed of wood, metal or other high strength material and may be fitted with rubber padding, finger grooves, or other affordances such as a grip member transverse to the longitudinal axis of the handle, to facilitate the use of tool by the operator. The fork body [4] includes a beam generally transverse to the longitudinal axis of the handle, and having an upper surface [8] and a lower surface [9.] A plurality of elongated tines [5] each have a first end connected to a base portion and an opposed free end. The fork body and its plurality of tines may be constructed as a single piece, and preferred embodiments of the tool include at least two tines. The tines are comprised of two segments, a proximal section [5a] and a distal section [5b] which is a base portion, with an obtuse angle between the segments, so that each of the tines is angled in an upward direction with reference to the upper surface. Another embodiment may have tines composed of two segments with an acute angle between the segments, which may be beneficial for raking plant matter and rocks or larger objects which do not pass between the tines, for the improvement of the soil for gardening.

FIG. 2 shows an exploded view of the weed removal tool of FIG. 1. The handle [3] may be attached to the fork body [4] of the tool by a screwing action or a friction fit, and may then be permanently secured by a pin or some other locking mechanism. The connection of the handle to the fork body may also be constructed with a swivel mount so that handle may be changed by the operator from a pushing configuration to a pulling configuration. The fork body may also include a tang [18] extending into and gripped by the handle.

The tool includes a span element [10] connected to the base at an intermediate portion along the length of each tine. The span element includes at least one portion or component having an acute cutting edge [12.] These portions may be separate knife blocks [11] attachable to the span, or may be integral to the span. According to a preferred embodiment, the span includes a first set of apertures which align with a subset from among a plurality of span attachment facilities [6] which reside at different positions along the lengths of the tines. The span may also include a second set of apertures [13] for fasteners used to attach the knife blocks to the span. The array of span attachment facilities in this embodiment shown is a rectangular array of threaded holes in the tines. The span may thus be secured perpendicular to the tines at any of a number of locations along the length of the tines, so that each of the tines may be angled at an intermediate location separated from the free end by the span

Also, although in this figure and others the span is shown oriented substantially transverse to the tines, in other embodiments appreciated by those skilled in the art the span may traverse tines at any other angle. The tines are preferably parallel to each other and may be spaced apart evenly or unevenly. It may be beneficial for the centermost tines to be spaced closer to each other rather than being equidistant with all of the tines. Another embodiment of the tool may have tines which are set at angles to one another rather than being parallel, such as a set of tines splayed or flaring apart at divergent angles from the beam portion of the fork body. Also, it is not necessary that the span extend across all of the tines, and the span may even be designed to be attached so that one or both of its ends extend beyond the first or the last tines, or extend laterally beyond both the first and last tines. Another alternative embodiment within the scope of the invention uses a span having its own cutting edges and no knife blocks.

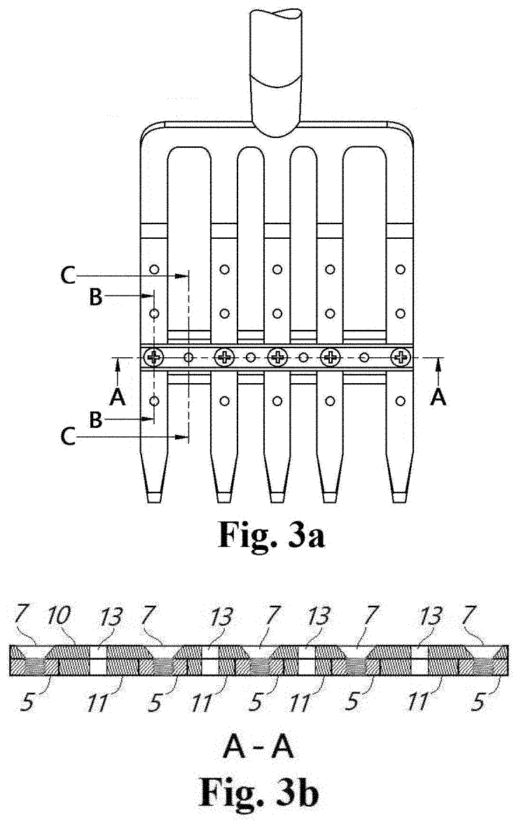

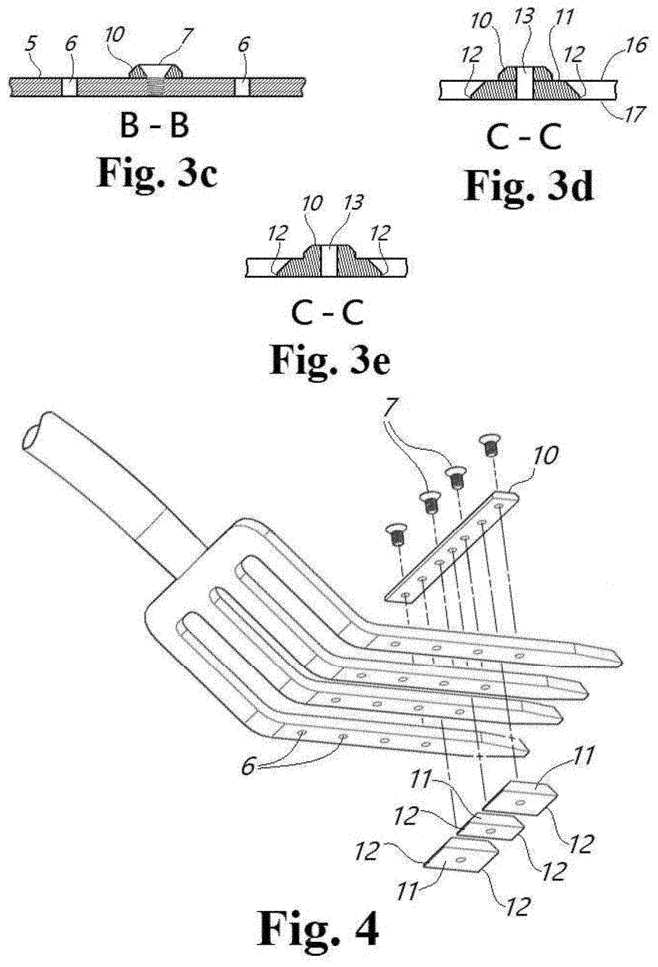

FIG. 3a shows a top view of the weed removal tool of FIG. 1 and defines section lines A-A and B-B for the cross section views of FIGS. 3b and 3c respectively, and defines section line C-C for the cross section views of FIGS. 3d and 3e. The span element has an elongated portion extending above the upper surface of the fork body and across the upper surfaces of all the tines.

FIG. 3b shows a cross section view of the weed removal tool of FIG. 1 taken at section line A-A of FIG. 3a. The span element [10] is secured to the tines [5] by threaded fasteners [7] which are seated in a first set of countersunk through holes in the span element and connect it to each of the tines. A second set of holes [13] is used to affix the knife blocks [11] to the span so they reside between the tines. These holes may receive threaded fasteners or force fit dowels whereby the knife blocks are installed onto the span by a press fit. In this embodiment shown the span cutting edges each extend between adjacent tines. Although the tool may be fashioned with evenly spaced tines, in this embodiment shown the tines define a plurality of gaps, and least one of the gaps has a width different from that of at least one of the other gaps. Thus in this embodiment shown the three center tines are clustered together with narrower gaps between their sidewalls, and the first and last tines are spaced further apart from the central cluster as outrigger tines.

FIG. 3c shows a cross section view of the weed removal tool of FIG. 1 taken at section line B-B of FIG. 3a. The span element [10] is secured to the tines by countersunk screws [7] and rests across their top surfaces. Other apertures [6] are span attachment facilities which reside at different positions along the lengths of the tines, so that the span element and its cutting edges may be adjustably installed closer to the tine tips or closer to the bend in the tines, as desired.

FIG. 3d shows a cross section view of the weed removal tool of FIG. 1 taken at section line C-C of FIG. 3a. The section line passes through the span [10] and a knife block [11] and through a hole [13] passing through both of these components. The knife blocks have cutting edges [12] on their forward-facing and backward-facing surfaces, and they are reversibly attachable and detachable to the span so that their cutting edges may operate while the tines are slid over the soil surface in both a forward motion extending away form the user and a reverse motion retracting toward the user. In the event of uneven wear between the forward and reverse motions, the knife blocks may be easily removed and reversed to extend the service life of the tool between cutting edge sharpening intervals.

The tines each have an upper surface [16] and a lower surface [17] and the span when installed rests upon the upper surfaces of the tines. The detachable knife blocks are trapezoidal and their acute cutting edges [12] reside adjacent to the lower surfaces of the tines. The fork body and its tines may be formed of different materials, and the knife blocks being made of yet another material. According to a preferred embodiment the fork body is made of steel and the span element is made of aluminum.

FIG. 3e shows a cross section view of a weed removal tool similar to that of FIG. 1 but having an alternative embodiment of a span element [10] comprising integral cutting edges [12.] This span may be formed as an extrusion with slots milled to admit the tines. As a single component this span element would be reversable to extend it service wear life. The secondary set of holes [13] may optionally be omitted for such as span element.

FIG. 4 shows an oblique, bottom front left view of an alternative embodiment of a weed removal tool in accordance with the invention having four tines, with its components exploded. Screws [7] mount the span [10] to screw receiving apertures [6] in the set of tines at any of several possible locations. The span, or its knife blocks, or both, may have either their forward or rearward edges sharpened, or they may have dual sharpened edges at both its forward edge and its rearward edge as shown in this figure. A span configured with dual sharpened edges will allow for the rearward edge to be used as a forward edge when span is removed, rotated, and reattached to tines. In this figure, it is seen that each of the tines is spaced apart by a gap defined between opposed parallel sidewalls of adjacent tines, and with the span cutting edges residing between the tines. The span as an assembly includes block portions [11] spanning each gap, with knife block portions that include acute cutting edges [12.]

Other means and arrangements of connecting span to tines so that the span may be detached and reattached to tines may be appreciated by one skilled in the art. As the span is used, its leading edge will become dull. To resolve this problem the operator may (i) remove span and replace it with another span that is sharpened and ready for use, (ii) remove span, resharpen its forward edge, then reattach the span to the tines, or (iii) if the span is sharpened on both its forward and rearward edges, the user may remove span, rotate it so that the rearward edge becomes the forward edge, and then reattach the span to the tines.

Also, the tips of tines may be varied with a high or low slope value. The tip of a tine may also be a point. It may be advantageous to form the tips of the laterally outermost tines as points so that when tool is rotated about 90 degrees or so, a tine configured with a pointed tip may be used to target unwanted plants that are found in tight spaces such as in cracks between two slabs of cement tiles. Other configurations for the tips of tines may be envisioned by those skilled in the art that are within the scope of this invention.

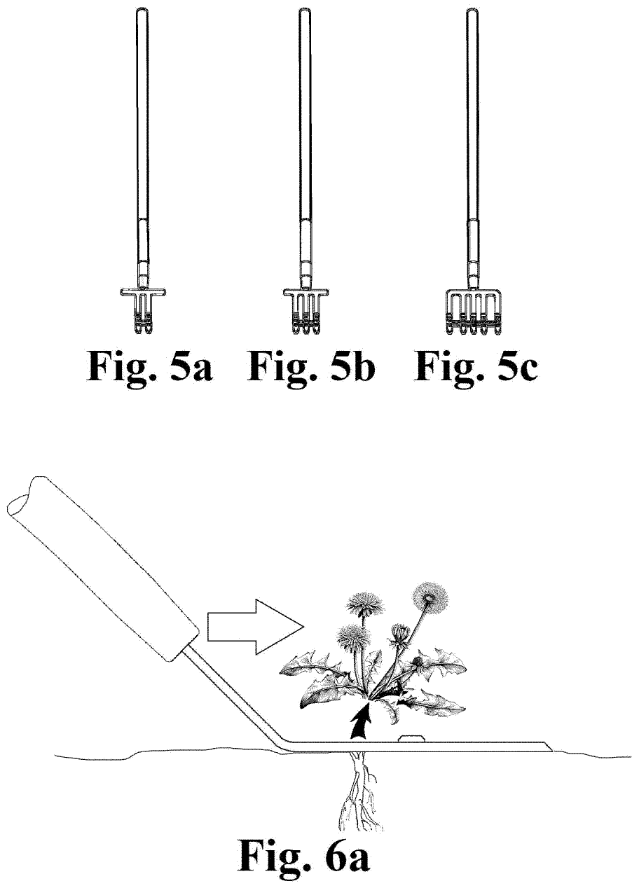

FIG. 5a shows a front view of an embodiment of a weed removal tool having two tines.

FIG. 5b shows a front view of an embodiment of a weed removal tool having three tines.

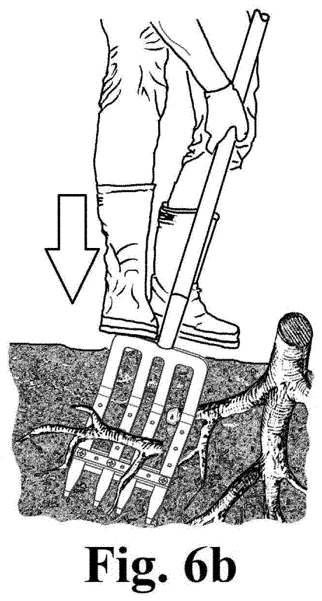

FIG. 5c shows a front view of an embodiment of the weed removal tool of FIG. 1. For embodiments of the tool wherein the number of tines is small or wherein the tines are clustered together close to the axis of the handle, the transverse beam portion of the fork body which unites the tines may include an elongated portion extending laterally beyond the first and last tines as seen in FIGS. 5a and 5b. The elongated portions may serve as a force or impact accepting surface for a users' foot, especially when using the tool vertically to probe downward into the soil or to work on objects beneath the soil surface as seen in FIG. 6b.

FIG. 6a shows an environmental use of the weed removal garden tool. The tool may be used to remove plants growing up out of the ground, by being positioned adjacent to a plant that is to be removed and then moved rapidly along the surface of the ground towards the plant by the operator of the tool. One skilled in the art will appreciate the fact that the handle must be at an appropriate angle to minimize the loss of power between the operator of the tool and the tool itself, and the bend angle between the proximal and distal portions of the portions of the tines may be selected so as to optimally direct a user's bodily force applied to the handle of the tool into maximally efficient horizontal impaction against the plants being destroyed and removed.

A white arrow in the figure depicts the motion of the tool, and a black arrow depicts a weed having its leafy above-ground portions severed from its root system by the passage of the cutting edges of the tool. As the tool approaches the plant, its tines come into contact with low lying leaves or runners from the plant that is to be removed, as well as leaves or runners from other nearby plants. The tines moving along the surface of the ground will act to lift these low-lying leaves or runners exposing the main stem of the plant. As tool continues to be moved forward, the leading sharpened edge of the span comes into contact with and severs and displaces the stem and upper portions of the plant. The operator may then retract and reposition the tool adjacent to another plant that is to be removed and repeat the process. With a span having knife edges facing in both forward and rearward directions, the chopping action of the tool may proceed both while the user extends and retracts the tool.

FIG. 6b shows another environmental use of a tool in accordance with the invention, wherein a user has severed a root below the soil surface. The upper surface of the transverse beam of the fork body readily accepts body weight or downward blows delivered by the sole of the user's foot as indicated by the white arrow. The cutting edges of the span may then encounter and sever larger roots beneath the soil surface, for destroying larger plants or for breaking roots in the vicinity of smaller stumps to be removed.

The foregoing description of the preferred embodiments of the invention have been presented for the purposes of illustration and description. It is not intended to be exhaustive or to limit the invention to the precise form disclosed. Many modifications and variations are possible in light of the above teaching.

I claim:

1. A garden tool comprising:
a fork body;
the fork body having base portion having an upper surface and a lower surface;
a plurality of elongated tines each having
a first end connected to the base portion, and
an opposed free end;
a span element connected to the base at an intermediate portion along the length of each tine, the span element having an acute cutting edge.

2. The garden tool of claim 1, wherein the tines each include a plurality of span attachment facilities at different positions along their lengths.

3. The garden tool of claim 1, wherein the tines are parallel to each other.

4. The garden tool of claim 1, wherein the span has an elongated portion above the upper surface of the fork body.

5. The garden tool of claim 1, wherein the span cutting edges are between the tines.

6. The garden tool of claim 1, wherein the span cutting edges are adjacent to the lower surface.

7. The garden tool of claim 1, wherein the span cutting edges each span between adjacent tines.

8. The garden tool of claim 1, wherein the span element is connected to each of the tines.

9. The garden tool of claim 1, wherein each of the tines has opposed parallel sidewalls.

10. The garden tool of claim 1, wherein each of the tines is angled at an intermediate location separated from the free end by the span.

11. The garden tool of claim 10, wherein each of the tines is angled in an upward direction with reference to the upper surface.

12. The garden tool of claim 1, wherein each of the tines is spaced apart by a gap.

13. The garden tool of claim 12, wherein the span includes a block portion spanning each gap, and including the acute cutting edge.

14. The garden tool of claim 12, wherein the tines define a plurality of gaps, and wherein at least one of the gaps has a width different from that of at least one of the other gaps.

15. The garden tool of claim 1, wherein the fork body and the span element are formed of different materials.

16. The garden tool of claim 15, wherein the fork body is steel and the span element is aluminum.

17. The garden tool of claim 1, including two tines.

18. The garden tool of claim 1, including three tines.

19. The garden tool of claim 1, including five tines.
